(19) United States
(12) Patent Application Publication
(10) Pub. No.: US 2021/0398141 A1
(43) Pub. Date: Dec. 23, 2021

(54) SYSTEMS AND METHODS FOR PREEMPTING CUSTOMER ACCEPTANCE OF PREDATORY LOAN OFFERS AND FRAUDULENT TRANSACTIONS

(71) Applicant: Capital One Services, LLC, McLean, VA (US)

(72) Inventors: Abdelkader Benkreira, New York, NY (US); Lin Ni Lisa Cheng, Fresh Meadows, NY (US); Vyjayanthi Vadrevu, Chicago, IL (US); Lea Katherine Cody, Arlington, VA (US)

(21) Appl. No.: 16/903,418

(22) Filed: Jun. 17, 2020

(51) Int. Cl. G06Q 30/00; G06Q 40/02; G06Q 50/26; H04L 29/06; G06N 20/00; G06N 5/04; H04W 4/021; G01S 19/01

(52) U.S. Cl. CPC G06Q 30/0185; G06Q 40/025; G06Q 50/265; G01S 19/01; G06N 20/00; G06N 5/04; H04W 4/021; H04L 63/0853

(57) ABSTRACT

System and devices for preempting customer acceptance of predatory loan offers is disclosed. The system may store customer account data and customer contact information. The system may determine an applicable first loan tier, each loan tier associated with a predetermined loan offer and indicative of a financial health of the customer. The first loan tier may be determined based on the customer account data. The system may receive a GPS signal indicating that the customer has entered and remained in a geofenced area associated with a predatory loan provider. In response to determining that the loan merchant is a predatory loan provider, the system may update customer account data and determine a second loan tier based on the updated customer account data, wherein the second loan tier is indicative of a higher risk loan than the first loan tier. Before offering the loan, the customer may be authenticated.

### FIELD OF INVENTION

Examples of the present disclosure relate to systems and methods for preempting customer acceptance of predatory loan offers and fraudulent transactions, and more particularly fraud detection, prevention, and mitigation systems that identify high-risk customers based on transaction data, detect the presence of a customer device at a predatory loan merchant, and either (i) authenticate the customer and selectively provide competing offer(s) or (ii) fail to authenticate the customer and initiate fraud prevention and/or fraud mitigation routine(s).

### BACKGROUND

With the deregulation of the consumer credit industry, the market for lending has advanced significantly. For example, most home improvement loans are tied to the equity on the home. Unfortunately, predatory lending practices have also emerged with the increase of customers that do not qualify for traditional loan packages. Predatory lending involves loan merchants that use high fees, charge extremely high and/or variable interest rates, and are often associate with other deceptive lending practices that are not favorable for a potential customer. Such unsavory lending practices usually target those customers most at risk for making unsound financial decisions. For example, predatory loan merchants are known to target poor, elderly, and minorities, who often lack access to traditional banking services and instead rely on predatory lenders when a cash advance is necessary. Additionally, predatory lending is more susceptible to fraud than traditional banking, and such fraud can damage and inconvenience the victim/customer, his/her traditional financial service provider, and/or the predatory loan merchant.

Accordingly, there is a need for systems and methods that preempt predatory loan offers by making customers aware of alternative loan products which may be more suitable and financially sound and that detect, prevent, and mitigate fraud in that industry. Examples of the present disclosure are directed to this and to other considerations.

### SUMMARY

Examples of the present disclosure comprise systems and methods for preempting predatory loan offers.

Consistent with the disclosed embodiments, various methods and systems are disclosed. In an embodiment, a system performing a method for preempting a predatory loan offer is disclosed. The system may store customer account data (e.g., balance data, prior transaction data, etc.) and customer contact information (e.g., primary contact information, secondary contact information). The system may determine, based on the customer account data, an applicable first loan tier of a plurality of loan tiers (e.g., indicative of a certain risk level for a respective customer). Each loan tier may be associated with a predetermined loan offer and the assigned loan tiers may be indicative of a financial health of the customer. The system may receive a GPS signal that indicates a first event in which a customer device associated with the customer enters and remains within a geofenced area for a first predetermined timeframe. The geofenced area may be associated with a loan merchant. Responsive to the first event, the system may identify a merchant category code associated with the loan merchant and determine whether the loan merchant is a predatory loan provider (e.g., a loan merchant providing high interest loan products). In response to determining that the loan merchant is a predatory loan provider, the method may include updating the customer account data (e.g., updating a credit score) and determining an applicable second loan tier that is indicative of a higher risk loan than the first loan tier. The system may request an authentication from the customer device within a second predetermined timeframe. When the authentication is not received, the method may include transmitting a fraud alert message to the customer and initiating a fraud monitoring routine. When the authentication is received, the method may include transmitting a predetermined second loan offer associated with the second loan tier to the customer device. In another embodiment, a device performing a method of preempting a predatory loan offer is also disclosed.

Further features of the disclosed design, and the advantages offered thereby, are explained in greater detail hereinafter with reference to specific examples illustrated in the accompanying drawings, wherein like elements are indicated be like reference designators.

### BRIEF DESCRIPTION OF THE DRAWINGS

Reference will now be made to the accompanying drawings, which are not necessarily drawn to scale, are incorporated into, and constitute a portion of, this disclosure, illustrate various implementations and aspects of the disclosed technology and, together with the description, serve to explain the principles of the disclosed technology. In the drawings:

FIG. 1A-1B are flowcharts of a method for preempting customer acceptance of a predatory loan, in accordance with some examples of the present disclosure;

FIG. 2A-2B are flowcharts of a method for preempting customer acceptance of a first-tier loan offer, in accordance with some examples of the present disclosure;

FIG. 3A-3B are flowcharts of a method for preempting customer acceptance of a predatory loan from a device perspective, in accordance with some examples of the present disclosure;

FIG. 4 illustrates an exemplary predatory loan preemption system consistent with disclosed embodiments; and

FIG. 5 is a component diagram of an exemplary predatory loan preemption system.

### DETAILED DESCRIPTION

Some implementations of the disclosed technology will be described more fully with reference to the accompanying drawings. This disclosed technology, however, may be embodied in many different forms and should not be construed as limited to the implementations set forth herein. The components described hereinafter as making up various elements of the disclosed technology are intended to be illustrative and not restrictive. Many suitable components that could perform the same or similar functions as components described herein are intended to be embraced within the scope of the disclosed systems and methods. Such other components not described herein may include, but are not limited to, for example, components developed after development of the disclosed technology.

It is also to be understood that the mention of one or more method steps does not imply a particular order of operation or preclude the presence of additional method steps or intervening method steps between those steps expressly identified. Similarly, it is also to be understood that the mention of one or more components in a device or system does not preclude the presence of additional components or intervening components between those components expressly identified.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

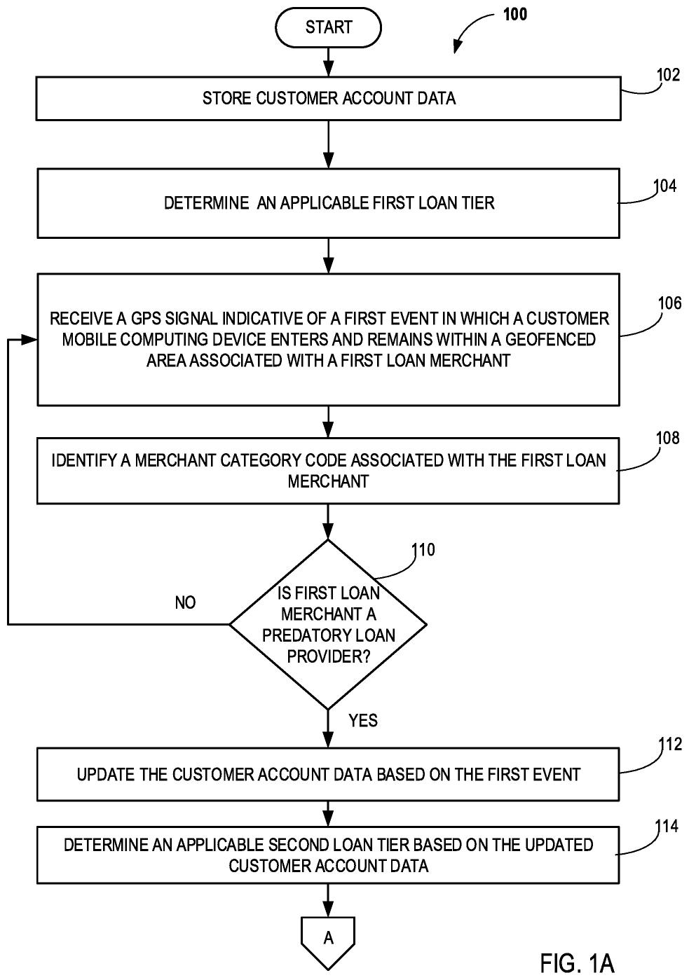

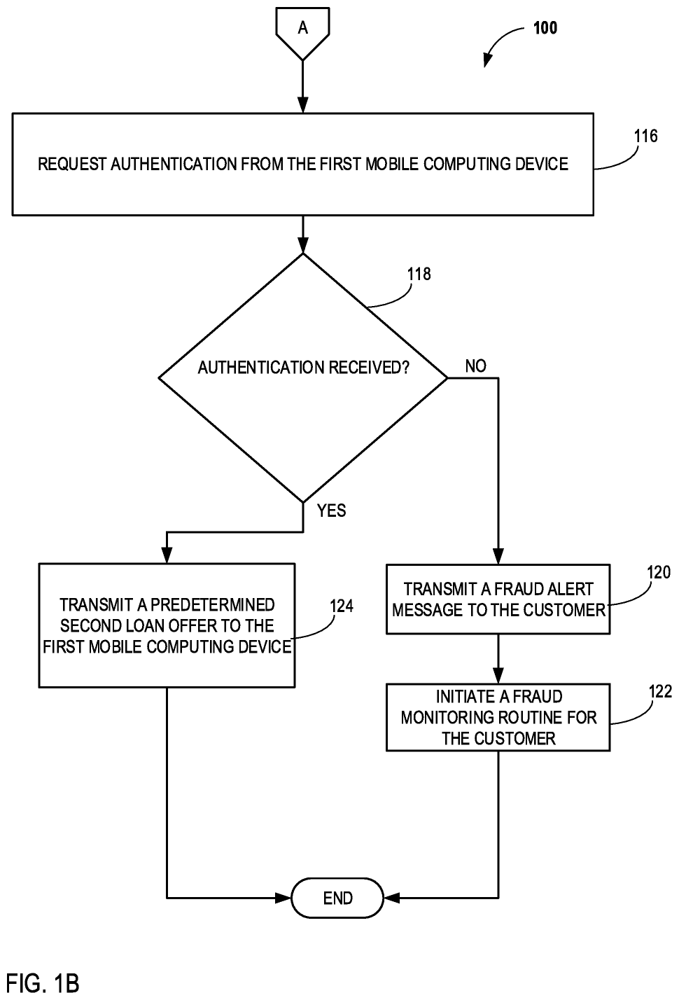

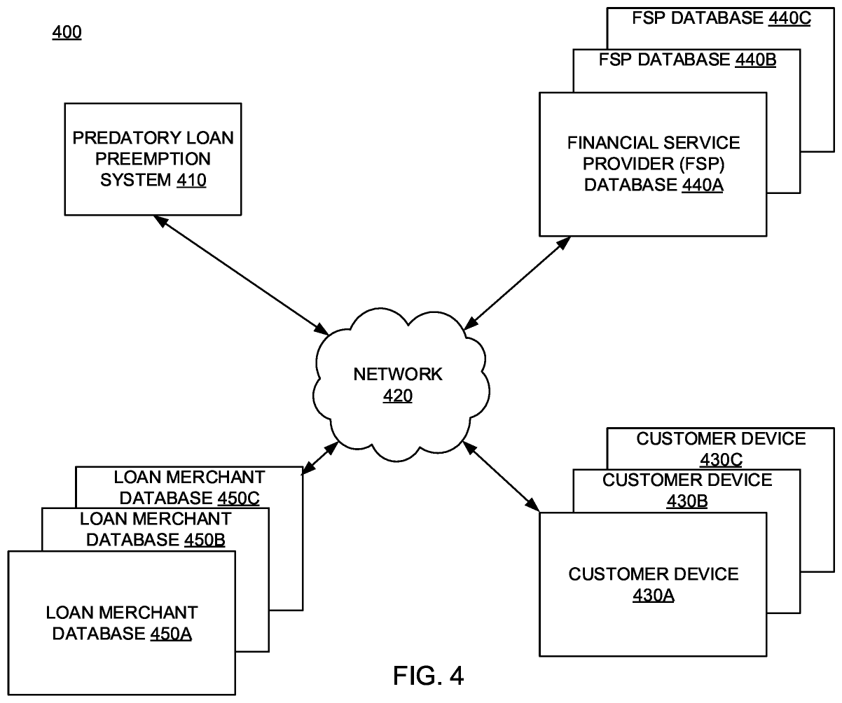

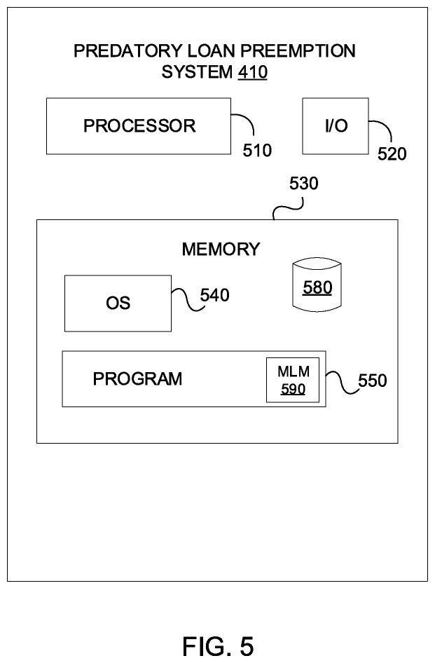

FIG. 1A-1B are flowcharts of a method 100 for preempting customer acceptance of a predatory loan, in accordance with some examples of the present disclosure. Although steps in method 100 are described as being performed by the system (e.g., a system 400 as described in more detail with respect to FIGS. 4-5), a person of ordinary skill in the art will understand that some or all of the steps of method 100 may be performed by one or more devices of the system (e.g., a customer device 430, as described in more detail with respect to FIGS. 4-5). As shown in FIG. 1A, in step 102 of method 100, the system may store customer account data. Customer account data may include prior transaction data, late payment data, and low balance data. Customer account data may also include information related to the customer's credit history including the customer's current credit score and historic credit score. In some embodiments, customer account data may be sourced from a financial service provider and/or from a loan merchant (e.g., a loan merchant with which the customer has transacted). Prior transaction data may include a transaction amount, a transaction timestamp, and an associated service or product purchased in the transaction. Prior transaction data may be used to predetermine a respective customer's risk profile based on his/her previous purchases and/or the customer's credit score. Late payment data may include transactions for which the respective customer may have made a late payment or missed a payment entirely. For example, if the respective customer has failed to make a car loan payment in the last year, this may be included in late payment data. Low balance data may include whether a checking account or savings account associated with the respective customer has a balance lower than a predetermined threshold. Such a low balance may be indicative of increased risk that the respective customer may not repay a future obligation.

In step 104, the system may determine, based on the customer account data, an applicable first loan tier. For example, if the respective customer is not late on any payments and does not have a low balance in his checking account, the system may determine that the respective customer is relatively low risk and may determine an applicable loan tier that indicates a low risk customer. For example, the system may determine a customer's risk based on previous payment history. If the customer has defaulted on a loan, made a series of late payments, and/or missed a payment on his or her credit card, the customer may be considered a higher risk customer. Additionally, if the customer has previously engaged a predatory loan provider in the past, the system may determine that the customer is higher risk. Other factors contributing to the applicable first loan tier determination include the customer's credit information.

In step 106, the system may receive a GPS signal indicative of a first event in which a customer device enters and remains within a geofenced area for a first predetermined timeframe. In some embodiments, the system may determine that the customer device is within the geofenced area based on a connection to a wireless network. For example, the customer device may connect to a wireless network associated with a respective loan merchant. The first predetermined timeframe may be based at least in part on a trained machine learning model configured to estimate a length of time indicative of the customer applying for a loan from the first loan merchant. For example, the trained machine learning model may have access to a plurality of customer devices, and may continuously monitor a length of time in which a respective customer device stays within a geofenced area indicative of a loan merchant. By additionally monitoring the financial accounts associated with such customer devices, the trained machine learning model may be configured to estimate an average length of time that the respective customer device remains within the geofenced area when the associated financial account indicates that the respective customer received a loan offer from the loan merchant. In some embodiments, the system may additionally call upon a third party application programming interface (API) to receive data indicative of average wait time for a given merchant. In some embodiments, the trained machine learning model may be configured to dynamically vary the time threshold indicative to the system that the respective customer may attempt to accept a predatory loan offer based on the specific merchant and/or an identified merchant category code indicative of a respective tier of loan merchant. In some embodiments, the trained machine learning model may be configured to dynamically vary the time threshold indicative to the system that the respective customer may attempt to accept a predatory loan offer based on the merchant category code. Other factors that the system may analyze in varying the time threshold may also include the respective customer's transaction history with the loan merchant. The geofenced area may be associated with a first loan merchant. For example, a respective customer carrying his/her associated mobile computing device may decide to enter an area associated with a loan merchant. If the mobile computing device is detected (i) entering the geofenced area and (ii) quickly leaving the area within, e.g., less than 10 minutes, the system determines that it is unlikely that the respective customer has taken any action (e.g., obtained a loan). However, when the mobile computing device remains within the geofenced area for longer (e.g., 10 minutes or more), this may be indicative of the respective customer attempting to receive a loan offer from a potentially predatory loan merchant.

In step 108, the system may identify a merchant category code associated with the first loan merchant. For example, the merchant category code may allow the system to distinguish between a regular loan merchant and a predatory loan merchant.

In decision block 110, the system may determine whether the first loan merchant is a predatory loan provider. For example, the system may receive a merchant code associated with the first loan merchant. The system may use the merchant code to determine whether the first loan merchant is a predatory loan provider by comparing the received merchant code to a predetermined list of merchant codes associated with predatory loan providers. In response to determining that the first loan merchant is not a predatory loan provider, the method may return back to step 106. In response to determining that the first loan merchant is a predatory loan provider, the method may continue to step 112.

In step 112, the system may update the customer account data based on the first event. For example, if the system detects that the respective customer has entered and remained within the geofenced area for a predetermined timeframe and that the first loan merchant is a predatory loan provider based on the identified merchant category code, the system may determine that the respective customer is a higher risk customer and should belong to higher-risk loan tier of the plurality of loan tiers and accordingly update the customer account data with, e.g., an adjusted credit score. To identify that the respective customer is a higher risk customer, the customer account data may be modified to include metadata indicative of a credit alert or flag based on the customer's activity with the first loan merchant.

In step 114, the system may determine an applicable second loan tier based on the updated customer account data. For example, the second loan tier may be indicative of a higher risk loan tier than the first loan tier originally determined for the respective customer.

As shown in FIG. 1B in step 116, the system may request an authentication from the customer device within a second predetermined timeframe. The authentication process may include providing a user name and password. The authentication process may additionally include requesting an authentication signal from a device associated with the customer device (e.g., a smart watch) and/or receiving a biometric authentication (e.g., a fingerprint scan, a facial identification scan, and the like) from the customer via the customer device. In some embodiments, a third-party service known in the art (e.g., PingID MFA), may be employed as a multi-factor cloud-based authentication solution. In some embodiments, the customer may receive a one-time PIN, text, code, email code, etc. in order to enable a multi-factor authentication process for authenticating the customer. In some embodiments, the system may authenticate the customer by receiving a photo and/or scan of a government ID card associated with the customer. In some embodiments, the system may authenticate the customer when the customer scans his or her credit card with a contactless method of communication, for example, near field communication (NFC) or with a radio frequency identification (RFID) scanner. In some embodiments, more than one authentication method may be presented to the customer as an option and the customer may choose his or her preferred method of authentication. For example, before the system transmits a loan offer to the customer device, it may be advantageous to determine whether the customer is still in possession of the customer device. There may be situations in which the customer device has been stolen, and the thief is the person requesting a loan from the loan merchant. Accordingly, it may be advantageous to request an authentication from the customer device within a second predetermined timeframe. In some embodiments, the authentication request may be transmitted to the customer device, but additionally an alert may be transmitted to the customer via a request sent to the customer's secondary contact information. This may be advantageous because if the customer device has been stolen, the thief will not be able to authenticate without access to the customer's secondary contact information—the customer device on its own would not suffice for the authentication to be completed when the authentication is request is sent to the customer's secondary contact information. To further discourage theft, the system may transmit a false authentication confirmation to the customer device and alert local police authorities responsive to receiving a confirmation from the customer secondary contact information that an unauthorized transaction is pending. In some embodiments, the authentication may include receiving an associated device signal from a device associated with the customer device. In other embodiments, the authentication may include combinations of logging into a financial account associated with the customer and/or receiving an associated device signal from a device associated with the customer device. For example, logging into a financial account may include requesting the customer to complete a secure login to a financial account to verify that the customer is indeed requesting the loan from the loan merchant, and that it is not a fraudulent transaction. Receiving an associated device signal from a device associated with the customer device may include receiving a signal from a device registered to the customer that a potential thief would likely not have access to even if the customer device is stolen. For example, an associated device may be a secondary wearable device that may be in short-range contactless communication with the customer device. Accordingly, authentication may include receiving a signal from the secondary device confirming the identity of the customer.

In decision block 118, the system may determine whether the authentication is received within the second predetermined timeframe. When the authentication is not received within the second predetermined timeframe, the method may move to step 120. When the authentication is received within the second predetermined timeframe, the method may move to step 124. In some embodiments, receiving the authentication may include logging into a financial account associated with the customer.

When the authentication is not received within the second predetermined timeframe, the method may move to step 120. In step 120, the system may transmit a fraud alert message to the customer. In some embodiments, the fraud alert message may be sent to the customer's secondary contact information, so as not to alert a potential thief that the system has determined that someone is attempting to complete a fraudulent transaction. In some embodiments, the fraud alert message may be sent to the customer device, but the message may not be displayed to avoid alerting the potential thief that the system has determined that someone is attempting to complete a fraudulent transaction. In some embodiments, a fake authentication confirmation may be sent to the customer device responsive to receiving confirmation from the customer secondary contact information that a fraudulent loan request has been made at a loan merchant. The thief may not be alerted to the detected fraud while the system alerts local police authorities of the location of the potentially fraudulent transaction.

In step 122, the system may initiate a fraud monitoring routine for the customer. In some embodiments, the fraud monitoring routine may be applied to the customer's financial accounts for a predetermined number of transactions based on the updated customer account data from step 112. Accordingly, the system may set the number of transactions which will be monitored by the fraud monitoring routine based on the newly determined loan tier from step 114. Besides monitoring a number of transactions, the fraud monitoring routine may include requiring secondary authentication for the number of transactions to be monitored. For example, the system may require second factor authentication requiring the customer to enter a code sent to a secure email account associated with the customer for the number of transactions being monitored by the activated fraud monitoring routine. Dynamically setting the number of subsequent transactions for fraud monitoring may be advantageous from the point of view of reducing network traffic. When the system determines that the risk of future fraud is relatively low, the system may reduce network traffic by reducing the number of subsequent transactions to be monitored for a respective customer. When the system determines that there is a high risk of future fraud, the system may sacrifice some network bandwidth for increased security associated with monitoring a greater number of subsequent transactions for potential fraud. The fraud monitoring routine may include monitoring the customer account(s) for potentially fraudulent transactions. In some embodiments, the customer account data may include information such as prior transaction data, late payment data, and low balance data. Prior transaction data may include any prior transactions associated with the customer's financial account. Late payment data may include any transactions associated with the customer's financial account in which the customer has failed to make a timely payment. Low balance data may include any accounts associated with the customer's financial account that may have a balance either (i) lower than a predetermined threshold or (ii) insufficient to make all necessary payments according to a financial obligation of the customer.

Alternatively, when the authentication is received within the second predetermined timeframe, the method may move to step 124. In step 124, the system may transmit a predetermined second loan offer associated with the second loan tier to the customer device. For example, once the system has determined a new loan tier for the customer (e.g., the second loan tier), the system may transmit an offer associated with the new loan tier. In some embodiments, the predetermined second loan offer may only be accepted in person, and the offer may include directions to a nearest financial service provider location associated with the predetermined second loan offer. In some embodiments, a first offer associated with the first loan tier and the predetermined second loan offer may both be based on and have a lower interest rate than an average predatory loan offer associated with the identified merchant category code. For example, the predetermined second loan offer may have better financial terms (e.g., interest rate, term) than an average loan offer associated with the loan merchant corresponding to the merchant category code as determined in step 108 of method 100. After step 124, method 100 may end.

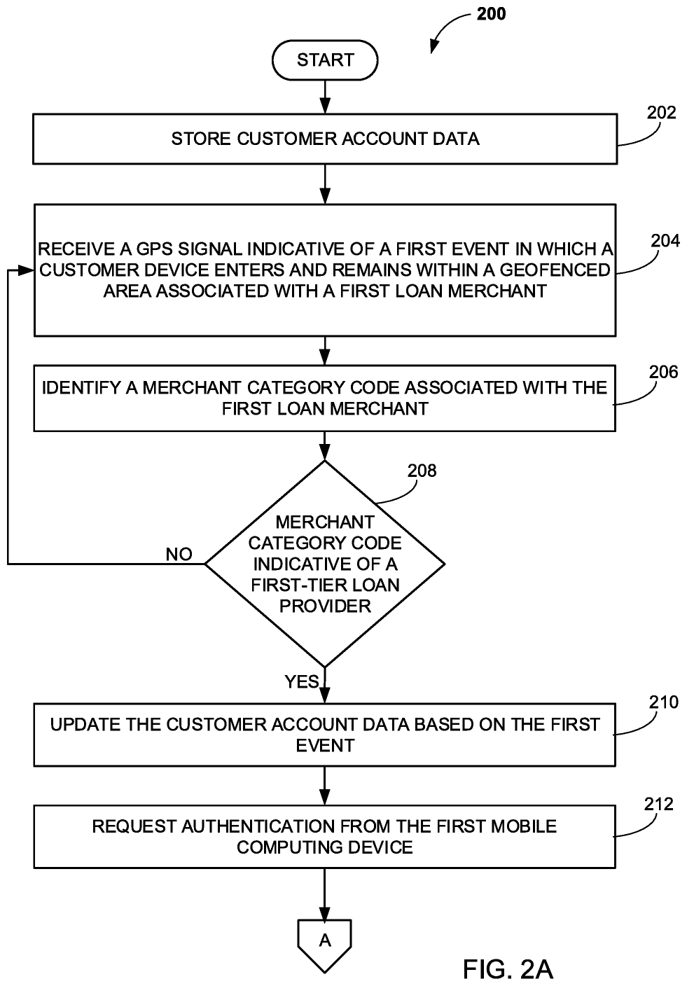

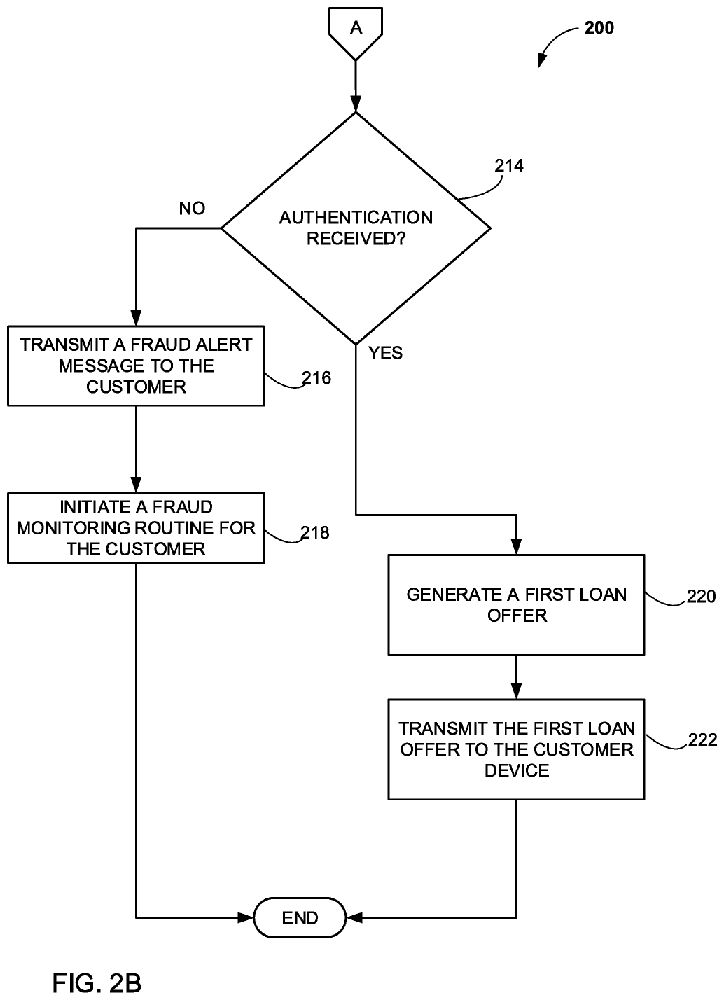

FIG. 2A-2B are flowcharts of a method for preempting customer acceptance of a first-tier loan offer, in accordance with some examples of the present disclosure. Although steps in method 100 are described as being performed by the system, a person of ordinary skill in the art will understand that some or all of the steps of method 100 may be performed by the device (e.g., customer device 430, as described in more detail with respect to FIGS. 4-5). As shown in FIG. 2A, in step 202 of method 200, the system may store customer account data. Customer account data may include prior transaction data, late payment data, and low balance data. Customer account data may also include information related to the customer's credit history including the customer's current credit score and historic credit score. In some embodiments, customer account data may be sourced from a financial service provider and/or from a loan merchant. Prior transaction data may include a transaction amount, a transaction timestamp, and an associated service or product purchased in the transaction. Prior transaction data may be used to predetermine a respective customer's risk profile based on his/her previous purchases. Late payment data may include transactions for which the respective customer may have made a late payment, or missed a payment entirely. For example, if the respective customer has failed to make a car loan payment in the last year, this may be included in late payment data. Low balance data may include whether a checking account or savings account associated with the respective customer has a balance lower than a predetermined threshold. Such a low balance may be indicative of increased risk that the respective customer may not repay a future obligation.

In step 204, the system may receive a GPS signal indicative of a first event in which a customer device enters and remains within a geofenced area for a first predetermined timeframe. The first predetermined timeframe may be based at least in part on a trained machine learning model configured to estimate a length of time indicative of the customer applying for a loan from the first loan merchant. For example, the trained machine learning model may have access to a plurality of customer devices, and may continuously monitor a length of time for which a respective customer device stays within a geofenced area indicative of a loan merchant. By additionally monitoring the financial accounts associated with such customer devices, the trained machine learning model may be configured to estimate an average length of time that the respective customer device remains within the geofenced area when the associated financial account indicates that the respective customer received a loan offer from the loan merchant. In some embodiments, the trained machine learning model may be configured to dynamically vary the time threshold indicative to the system that the respective customer may attempt to accept a predatory loan offer based on the specific merchant and/or an identified merchant category code indicative of a respective tier of loan merchant. In some embodiments, the trained machine learning model may be configured to dynamically vary the time threshold indicative to the system that the respective customer may attempt to accept a predatory loan offer based on the merchant category code. Other factors that the system may analyze in varying the time threshold may also include the respective customer's transaction history with the loan merchant. The geofenced area may be associated with a first loan merchant. For example, a respective customer carrying his/her associated customer device may decide to enter an area associated with a loan merchant. If the mobile customer device is detected (i) entering the geofenced area and (ii) quickly leaving the area within, e.g., less than 10 minutes, the system determines that it is unlikely that the respective customer has taken any action (e.g., obtained a loan). However, when the customer device remains within the geofenced area for longer (e.g., 10 minutes or more), this may be indicative of the respective customer attempting to receive a loan offer from a potentially predatory loan merchant. In some embodiments, the system may additionally call upon a third party application programming interface (API) to receive data indicative of average wait time for a given merchant. For example, the system may access a database indicating that customers of predatory loan merchant A typically spend an average of 25 minutes within the establishment and may set the predetermined timeframe at 25 minutes.

In step 206, the system may identify a merchant category code associated with the first loan merchant. For example, the merchant category code may allow the system to distinguish between a regular loan merchant and a predatory loan merchant.

In decision block 208, the system may determine whether the merchant category code is indicative of a first-tier loan provider. In response to determining that the first loan merchant is not a first-tier provider, the method may return back to step 204. In response to determining that the first loan merchant is a first-tier loan provider, the method may continue to step 210. In some embodiments, a first-tier loan provider is a loan provider that is a non-bank lender. In some embodiments, a first-tier loan provider offers loan products with higher average interests rates than those offered by non-first-tier loan providers.

In step 210, the system may update the customer account data based on the first event. For example, if the system detects that the respective customer has entered and remained within the geofenced area for a predetermined timeframe and that the first loan merchant is a first-tier loan provider based on the identified merchant category code, the system may determine that the respective customer is a higher risk customer and should belong to higher-risk loan tier of the plurality of loan tiers and accordingly update the customer account data with, e.g., an adjusted credit score.

In step 212, the system may request an authentication from the customer device within a second predetermined timeframe. The authentication process may include providing a user name and password. The authentication process may additionally include requesting an authentication signal from a device associated with the customer device (e.g., a smart watch) and/or receiving a biometric authentication (e.g., a fingerprint scan, a a facial identification scan, and the like) from the customer via the customer device. For example, before the system transmits a loan offer to the customer device, it may be advantageous to determine whether the customer is still in possession of the customer device. There may be situations in which the customer device has been stolen, and the thief is the person requesting a loan from the loan merchant. Accordingly, it may be advantageous to request an authentication from the customer device within a second predetermined timeframe. In some embodiments, the authentication request may be transmitted to the customer device, but additionally an alert may be transmitted to the customer via a request sent to the customer's secondary contact information. This may be advantageous because if the customer device has been stolen, the thief will not be able to authenticate without access to the customer's secondary contact information—the customer device on its own would not suffice for the authentication to be completed when the authentication is request is sent to the customer's secondary contact information. To further discourage theft, the system may transmit a false authentication confirmation to the customer device and alert local police authorities responsive to receiving a confirmation from the customer secondary contact information that an unauthorized transaction is pending. In some embodiments, the authentication may include receiving an associated device signal from a device associated with the customer device. In other embodiments, the authentication may include combinations of logging into a financial account associated with the customer and/or receiving an associated device signal from a device associated with the customer device. For example, logging into a financial account may include requesting the customer to complete a secure login to a financial account to verify that the customer is indeed requesting the loan from the loan merchant, and that it is not a fraudulent transaction. Receiving an associated device signal from a device associated with the customer device may include receiving a signal from a device registered to the customer that a potential thief would likely not have access to even if the customer device is stolen. For example, an associated device may be a secondary wearable device that may be in short-range contactless communication with the customer device. Accordingly, authentication may include receiving a signal from the secondary device confirming the identity of the customer.

As shown in FIG. 2B, in decision block 214, the system may determine whether the authentication is received within the second predetermined timeframe. When the authentication is not received within the second predetermined timeframe, the method may move to step 216. When the authentication is received within the second predetermined timeframe, the method may move to step 220.

When the authentication is not received within the second predetermined timeframe, the method may move to step 216. In step 216, the system may transmit a fraud alert message to the customer. In some embodiments, the fraud alert message may be sent to the customer's secondary contact information, so as not to alert a potential thief that the system has determined that someone is attempting to complete a fraudulent transaction. In some embodiments, the fraud alert message may be sent to the customer device, but the message may not be displayed to avoid alerting the potential thief that the system has determined that someone is attempting to complete a fraudulent transaction. In some embodiments, a fake authentication confirmation may be sent to the customer device responsive to receiving confirmation from the customer secondary contact information that a fraudulent loan request has been made at a loan merchant. The thief may not be alerted to the detected fraud while the system alerts local police authorities of the location of the potentially fraudulent transaction.

In step 218, the system may initiate a fraud monitoring routine for the customer. In some embodiments, the fraud monitoring routine may be applied to the customer's financial accounts for a predetermined number of transactions based on the updated customer account data from step 210. Accordingly, the system may set the number of transactions which will be monitored by the fraud monitoring routine based on the updated customer account data from step 210. Dynamically setting the number of subsequent transactions for fraud monitoring may be advantageous from the point of view of reducing network traffic. When the system determines that the risk of future fraud is relatively low, the system may reduce network traffic by reducing the number of subsequent transactions to be monitored for a respective customer. When the system determines that there is a high risk of future fraud, the system may sacrifice some network bandwidth for increased security associated with monitoring a greater number of subsequent transactions for potential fraud. The fraud monitoring routine may include monitoring the customer account(s) for potentially fraudulent transactions. In some embodiments, the customer account data may include information such as prior transaction data, late payment data, and low balance data. Prior transaction data may include any prior transactions associated with the customer's financial account. Late payment data may include any transactions associated with the customer's financial account in which the customer has failed to make a timely payment. Low balance data may include any accounts associated with the customer's financial account that may have a balance either (i) lower than a predetermined threshold or (ii) insufficient to make all necessary payments according to a financial obligation of the customer.

Alternatively, when the authentication is received within the second predetermined timeframe, the method may move to step 220. In step 220, the system may generate a first loan offer based on the updated customer account data from step 210. In some embodiments, the first loan offer may only be accepted in person, and the first loan offer may include directions to a nearest financial service provider location associated with the first loan offer. In some embodiments, the first offer may be based on and have a lower interest rate than an average first-tier loan offer associated with the identified merchant category code. For example, the first loan offer may have better financial terms (e.g., interest rate, term) than an average loan offer associated with the loan merchant corresponding to the merchant category code as determined in step 208 of method 200. In step 222, the system (e.g., system 400, described in more detail with respect to FIGS. 4-5) may transmit the first loan offer to the customer device. After step 222, method 200 may end.

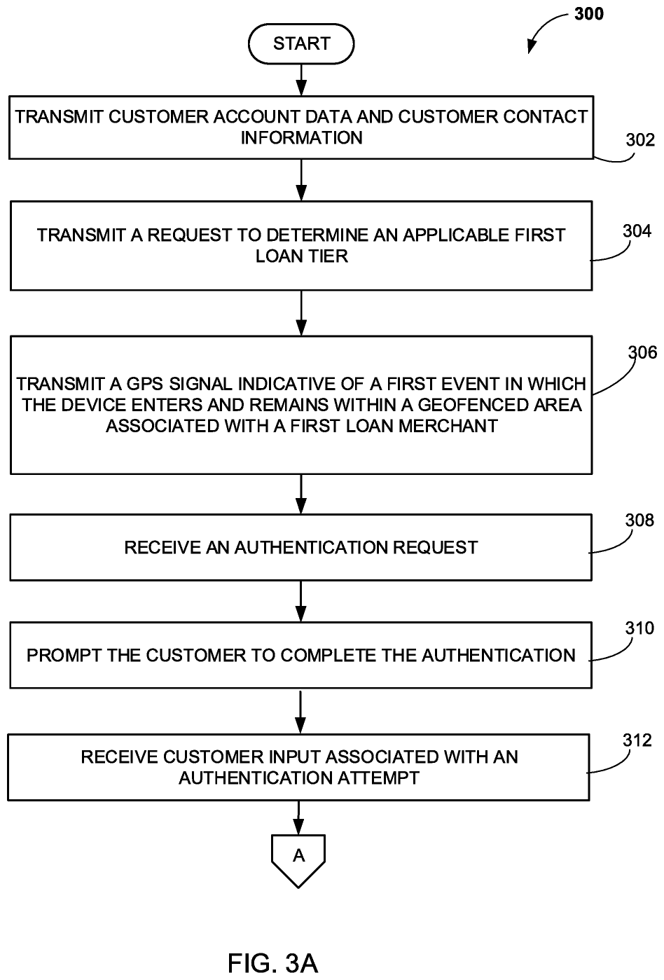

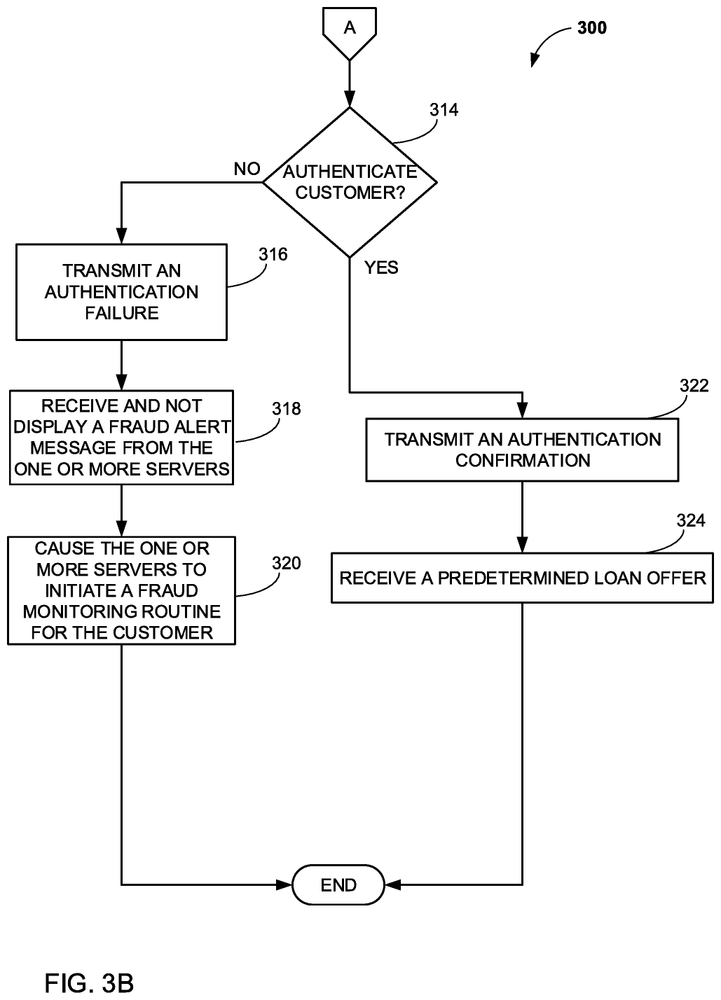

FIG. 3A-3B are flowcharts of a method for preempting customer acceptance of a predatory loan from a device perspective, in accordance with some examples of the present disclosure. Although steps in method 100 are described as being performed by the device (e.g., customer device 430, as described in more detail with respect to FIGS. 4-5), a person of ordinary skill in the art will understand that some or all of the steps of method 100 may be performed by the system (e.g., predatory loan preemption system 410, as described in more detail with respect to FIGS. 4-5). As shown in FIG. 3A, in step 302 of method 300, the device (e.g., customer device 430, described in more detail with respect to FIGS. 4-5) may transmit, to one or more servers, customer account data and customer contact information. In some embodiments, the customer account data may include prior transaction data, late payment data, and low balance data. Customer account data may also include information related to the customer's credit history including the customer's current credit score and historic credit score. Customer account data may additionally include other financial information including any currently outstanding loans (including the loan terms such as interest rate, loan term, etc.), debt to income ratio, etc. In some embodiments, the system may receive permission from the customer to access one or more third party APIs to receive additional customer account data from one or more third party financial institutions. In some embodiments, customer account data may be stored locally on the device (e.g., customer device 430), or may be sourced from one of a financial service provider and/or a loan merchant. Prior transaction data may include a transaction amount, a transaction timestamp, and an associated service or product purchased in the transaction. Prior transaction data may be used to predetermine a respective customer's risk profile based on his/her previous purchases. Late payment data may include transactions for which the respective customer may have made a late payment, or missed a payment entirely. For example, if the respective customer has failed to make a car loan payment in the last year, this may be included in late payment data. Low balance data may include whether a checking account or savings account associated with the respective customer has a balance lower than a predetermined threshold. Such a low balance may be indicative of increased risk that the respective customer may not repay a future obligation.

In step 304, the device (e.g., customer device 430 may transmit a request to the one or more servers to determine, based on the customer account data, an applicable first loan tier of a plurality of loan tiers. For example, if the respective customer is not late on any payments, and does not have a low balance in his checking account, the system (e.g., predatory loan preemption system 410) may determine that the respective customer is relatively low risk and may determine an applicable loan tier that indicates a low risk customer.

In step 306, the device (e.g., customer device 430) may transmit, to the one or more servers, a GPS signal indicative of a first event in which the device enters and remains within a geofenced area for a first predetermined timeframe, wherein the geofenced area is associated with a first loan merchant. The first predetermined timeframe may be based at least in part on a trained machine learning model configured to estimate a length of time indicative of the customer applying for a loan from the first loan merchant. For example, the trained machine learning model may have access to a plurality of customer devices (e.g., customer device 430), and may continuously monitor a length of time in which a respective customer device stays within a geofenced area indicative of a loan merchant. By additionally monitoring the financial accounts associated with such customer devices, the trained machine learning model may be configured to estimate an average length of time that the respective customer device remains within the geofenced area when the associated financial account indicates that the respective customer received a loan offer from the loan merchant. In some embodiments, the trained machine learning model may operate locally on the device (e.g., customer device 430) while in other embodiments, some or all of the steps associated with the trained machine learning model may be implemented on the one or more servers (e.g., predatory loan preemption system 410). In some embodiments, the trained machine learning model may be configured to dynamically vary the time threshold indicative to the system that the respective customer may attempt to accept a predatory loan offer based on the specific merchant and/or an identified merchant category code indicative of a respective tier of loan merchant. In some embodiments, the trained machine learning model may be configured to dynamically vary the time threshold indicative to the system that the respective customer may attempt to accept a predatory loan offer based on the merchant category code. Other factors that the system may analyze in varying the time threshold may also include the respective customer's transaction history with the loan merchant. The geofenced area may be associated with a first loan merchant. For example, a respective customer carrying his/her associated device may decide to enter an area associated with a loan merchant. If the device is detected (i) entering the geofenced area and (ii) quickly leaving the area within, e.g., less than 10 minutes, the system determines that it is unlikely that the respective customer has taken any action (e.g., obtained a loan). However, when the device remains within the geofenced area for longer (e.g., 10 minutes or more), this may be indicative of the respective customer attempting to receive a loan offer from a potentially predatory loan merchant.

In step 308, the device (e.g., customer device 430) may receive an authentication request form the one or more servers (e.g., predatory loan preemption system 410). For example, before the system transmits a loan offer to the device, it may be advantageous to determine whether the customer is still in possession of the device. There may be situations in which the customer's device has been stolen, and the thief is the person requesting a loan from the loan merchant. Accordingly, it may be advantageous to request an authentication from the device within a second predetermined timeframe. In some embodiments, the authentication may be requested via a request sent to the customer's secondary contact information. This may be advantageous, because if the device has been stolen, the thief will not be able to complete authentication without access to the customer's secondary contact information—the device on its own would not suffice for the authentication to be completed when the authentication request is sent to the customer's secondary contact information.

In step 310, the device (e.g. customer device 430) may prompt the customer to complete the authentication within a second predetermined timeframe. In step 312, the device (e.g., customer device 430) may receive customer input associated with an authentication attempt. In some embodiments, an authentication attempt may include logging into a financial account associated with the customer. In some embodiments, the authentication may include providing an associated device signal from a device associated with the device. In other embodiments, the authentication may include combinations of logging into a financial account associated with the customer and/or receiving an associated device signal from a device associated with the device. For example, logging into a financial account may include requesting the customer to complete a secure login to a financial account to verify that the customer is indeed requesting the loan from the loan merchant, and that it is not a fraudulent transaction. Transmitting an associated device signal from a device associated with the first mobile computing device may include transmitting a signal from a device registered to the customer that a potential thief would likely not have access to even if the customer's device (e.g., customer device 430) is stolen. For example, an associated device may be a secondary wearable device that may be in short-range contactless communication with the first mobile computing device. Accordingly, authentication may include receiving a signal from the secondary device confirming the identity of the customer.

As shown in FIG. 3B, in decision block 314, the device (e.g., customer device 430), the requests the system (e.g., predatory loan preemption system 410) to authenticate the customer. As discussed with respect to step 312, authenticating the user may include combinations of logging into a financial account associated with the customer and/or receiving an associated device signal from a device associated with the device. When the customer is not authenticated, method 300 moves to step 316. When the customer is authenticated, method 300 moves to step 322.

When the customer is not authenticated, method 300 moves to step 316. In step 316, the device (e.g., customer device 430) may transmit an authentication failure to the one or more servers (e.g., to predatory loan preemption system 410). For example, when the customer may not be authenticated, the customer device may transmit a message indicating that the authentication was a failure to the one or more servers of the system.

In step 318, the device (e.g., customer device 430) may receive, and not display a fraud alert message form the one or more servers. For example, the device may not display the received fraud alert message in order not to potentially alert a thief that his/her fraudulent transaction using a customer's stolen device has been detected. In some embodiments, the fraud alert message may be sent to the customer's secondary contact information that is different from the contact information for the device (e.g., customer device 430), so as not to alert a potential thief that the system (e.g., predatory loan preemption system 410) has determined that someone is attempting to complete a fraudulent transaction.

In step 320, the device (e.g., customer device 430) may cause the one or more servers (e.g., predatory loan preemption system 410) to initiate a fraud monitoring routine for the customer. In some embodiments, the fraud monitoring routine may be applied to the customer's financial accounts for a predetermined number of transactions based on the customer account data from step 302. Accordingly, the system may dynamically change the number of transactions which will be monitored by the fraud monitoring routine based on the customer account data from step 302. After step 320, method 300 may end. In some embodiments, the customer account data may include information such as prior transaction data, late payment data, and low balance data. Prior transaction data may include any prior transactions associated with the customer's financial account. Late payment data may include any transactions associated with the customer's financial account in which the customer has failed to make a timely payment. Low balance data may include any accounts associated with the customer's financial account that may have a balance either (i) lower than a predetermined threshold or (ii) insufficient to make all necessary payments according to a financial obligation of the customer.

When the customer is authenticated, method 300 moves to step 322. In step 322, the device (e.g., customer device 430) may transmit an authentication confirmation to the one or more servers. In step 324, the device (e.g., customer device 430) may receive a predetermined loan offer associated with a second loan tier of the plurality of loan tiers. The predetermined loan offer associated with the second loan tier may be determined to apply to the customer based on an updated version of the customer account data that factors in the first event described in more detail with respect to step 306, as shown in FIG. 3A. In some embodiments, the predetermined loan offer may only be accepted in person, and the predetermined loan offer may include directions to a nearest financial service provider location associated with the predetermined loan offer. In some embodiments, the predetermined offer may be based on and have a lower interest rate than an average predatory loan offer associated with the identified merchant category code. For example, the predetermined loan offer may have better financial terms (e.g., interest rate, term) than an average loan offer associated with the loan merchant corresponding to the geofenced area as determined in step 306 of method 300. After step 324, method 300 may end.

FIG. 4 illustrates an exemplary predatory loan preemption system consistent with disclosed embodiments. The example system environment of FIG. 4 may be used to implement one or more embodiments of the present disclosure. The components and arrangements shown in FIG. 4 are not intended to limit the disclosed embodiments as the components used to implement the disclosed processes and features may vary.

In accordance with the disclosed embodiments, system 400 may include a predatory loan preemption system 410 in communication with one or more customer devices 430A, 430B, 430C, etc. (collectively customer devices 430). The predatory loan preemption system 410 may use network 420 to communicate with the various other components of system 400. In some embodiments, predatory loan preemption system 410 may also be in communication with various databases. For example, predatory loan preemption system 410 may be in communication with one or more financial service provider databases 440A, 440B, 440C, etc. (collectively referred to as financial service provider databases 440). The one or more financial service provider databases may store customer account data that the system (e.g., via predatory loan preemption system 410 and/or customer device 430) may download for storage and further analysis according to exemplary embodiments discussed herein. Predatory loan preemption system 410 may also be in communication with one or more loan merchant databases 450A, 450B, 450C, etc. (collectively referred to as loan merchant databases 450). The loan merchant databases 450 may have customer account data available for the system to access. Customer devices 430 may be mobile computing devices (e.g., smart phones, tablet computers, smart wearable devices, portable laptop computers, voice command device, wearable augmented reality device, or other mobile computing device).

Network 420 may be of any suitable type, including individual connections via the internet such as cellular or WiFi networks. In some embodiments, network 420 may connect terminals using direct connections such as radio-frequency identification (RFID), near-field communication (NFC), Bluetooth™, low-energy Bluetooth™ (BLE), WiFi™, ZigBee™ ambient backscatter communications (ABC) protocols, USB, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

An example embodiment of predatory loan preemption system 410 is shown in more detail in FIG. 5. Customer device 430 may have a similar structure and components that are similar to those described with respect to predatory loan preemption system 410. As shown, predatory loan preemption system 410 may include a processor 510, an input/output (“I/O”) device 520, a memory 530 containing an operating system (“OS”) 540, a program 550, and a database 580. The program may additionally include a machine learning model 590. For example, predatory loan preemption system 410 may be a single server or may be configured as a distributed computer system including multiple servers or computers that interoperate to perform one or more of the processes and functionalities associated with the disclosed embodiments. In some embodiments, predatory loan preemption system 410 may further include a peripheral interface, a transceiver, a mobile network interface in communication with processor 510, a bus configured to facilitate communication between the various components of the predatory loan preemption system 410, and a power source configured to power one or more components of predatory loan preemption system 410.

A peripheral interface may include the hardware, firmware and/or software that enables communication with various peripheral devices, such as media drives (e.g., magnetic disk, solid state, or optical disk drives), other processing devices, or any other input source used in connection with the instant techniques. In some embodiments, a peripheral interface may include a serial port, a parallel port, a general-purpose input and output (GPIO) port, a game port, a universal serial bus (USB), a micro-USB port, a high definition multimedia (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™ ambient backscatter communications (ABC) protocols or similar technologies.

A mobile network interface may provide access to a cellular network, the Internet, or another wide-area network. In some embodiments, a mobile network interface may include hardware, firmware, and/or software that allows processor(s) 510 to communicate with other devices via wired or wireless networks, whether local or wide area, private or public, as known in the art. A power source may be configured to provide an appropriate alternating current (AC) or direct current (DC) to power components.

As described above, predatory loan preemption system 410 may configured to remotely communicate with one or more other devices, such as customer device 430. According to some embodiments, predatory loan preemption system 110 may utilize a trained machine learning model 590 to estimate an average length of time that the respective mobile device remains within the geofenced area when the associated financial account indicates that the respective customer received a loan offer from the loan merchant.

Processor 510 may include one or more of a microprocessor, microcontroller, digital signal processor, co-processor or the like or combinations thereof capable of executing stored instructions and operating upon stored data. Memory 530 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein are implemented as a combination of executable instructions and data within the memory 530.

Processor 510 may be one or more known processing devices, such as a microprocessor from the Pentium™ family manufactured by Intel™ or the Turion™ family manufactured by AMD™. Processor 510 may constitute a single core or multiple core processor that executes parallel processes simultaneously. For example, processor 510 may be a single core processor that is configured with virtual processing technologies. In certain embodiments, processor 510 may use logical processors to simultaneously execute and control multiple processes. Processor 510 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

Predatory loan preemption system 410 may include one or more storage devices configured to store information used by processor 510 (or other components) to perform certain functions related to the disclosed embodiments. In one example, predatory loan preemption system 410 may include memory 530 that includes instructions to enable processor 510 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, predatory loan preemption system 410 may include memory 530 that includes instructions that, when executed by processor 510, perform one or more processes consistent with the functionalities disclosed herein. Methods, systems, and articles of manufacture consistent with disclosed embodiments are not limited to separate programs or computers configured to perform dedicated tasks. For example, predatory loan preemption system 410 may include memory 530 that may include one or more programs 550 to perform one or more functions of the disclosed embodiments. Moreover, processor 510 may execute one or more programs 550 located remotely from predatory loan preemption 410. For example, predatory loan preemption system 410 may access one or more remote programs 550, that, when executed, perform functions related to disclosed embodiments.

Memory 530 may include one or more memory devices that store data and instructions used to perform one or more features of the disclosed embodiments. Memory 530 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational databases. Memory 530 may include software components that, when executed by processor 510, perform one or more processes consistent with the disclosed embodiments. In some embodiments, memory 530 may include an internal database 580 for storing a plurality of open-source caption files to enable predatory loan preemption system 410 to perform one or more of the processes and functionalities associated with the disclosed embodiments.

Predatory loan preemption system 410 may also be communicatively connected to one or more memory devices (e.g., databases (not shown)) locally or through a network. The remote memory devices may be configured to store information and may be accessed and/or managed by predatory loan preemption system 410. By way of example, the remote memory devices may be document management systems, Microsoft™ SQL database, SharePoint™ databases, Oracle™ databases, Sybase™ databases, or other relational databases. Systems and methods consistent with disclosed embodiments, however, are not limited to separate databases or even to the use of a database.

Predatory loan preemption system 410 may also include one or more I/O devices 520 that may include one or more interfaces for receiving signals or input from devices and providing signals or output to one or more devices that allow data to be received and/or transmitted by predatory loan preemption system 410. For example, predatory loan preemption system 410 may include interface components, which may provide interfaces to one or more input devices, such as one or more keyboards, mouse devices, touch screens, track pads, trackballs, scroll wheels, digital cameras, microphones, sensors, and the like, that enable predatory loan preemption system 410 to receive data from one or more users (e.g., customer device(s) 430). Additionally, I/O 520 may include the audiovisual recorder utilized for receiving a feedback based on the event attended by the user.

In example embodiments of the disclosed technology, predatory loan preemption system 410 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While predatory loan preemption system 410 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of predatory loan preemption system 410 may include a greater or lesser number of components than those illustrated.

### Example Use Case

The following example use case describes an exemplary implementation of the systems and methods for predatory loan preemption described herein. It is intended solely for explanatory purposes and not to limit the disclosure in any way. A customer having an account with a particular financial service provider may be shopping around for a loan product. The financial service provider, which may be a traditional banking lender, wants to help its customer make prudent long-term investments to decrease risk of the customer defaulting on existing investments and to prevent fraud that could damage both the financial service provider and the customer. Although ill advised, the customer may enter a geofenced area associated with a potentially predatory loan merchant. The customer may not know that he/she has alternatives to using a high-interest lender, such a predatory loan lender, or the customer simply may not know that the respective loan merchant is a potentially predatory loan merchant. The system (e.g., predatory loan preemption system 410) may determine, based on the GPS signal from the customer device (e.g., customer device 430), that the customer has entered the geofenced area. The system may determine, based on an identified merchant category code, that the loan merchant being visited by the customer is a predatory loan merchant. In response the system (e.g., predatory loan preemption system 410) may transmit an authentication request to the customer device (e.g., customer device 430). In some embodiments, the authentication request may be transmitted to a customer's secondary contact information instead of directly to the customer device. This may be the case when an extra layer of security is preferred, because then a potential thief who has come into possession of the customer device may not be able to authenticate that he/she is the customer without also having access to secondary contact information. In other embodiments, the authentication request may include transmitting a signal associated with an associated device, such as a wearable smart watch and the like. It is unlikely that a thief would have possession of both the customer device and an associated device, increasing the likelihood that a thief will not be able to authenticate himself/herself as the customer. Once the customer has been authenticated, the system may generate and transmit a customized loan offer to the customer based on the customer's account data to compete with an offer from the predatory loan merchant. The account data may include data indicating the level of risk associated with providing the customer a loan package, and based on the account data, the system may determine an appropriate loan tier based on the level of risk, and offer the loan product to the customer. The customer may receive the loan offer on the customer device, which may include directions to the nearest location of the financial service provider associated with the competing offer. In any instance, the competing loan offer always has loan terms more favorable to the customer than those offered by a predatory loan merchant. In this way, the customer may avoid entering into unfavorable loan agreements.

In another example, the customer may already know that the loan merchant is a potentially predatory loan merchant, but may nevertheless choose to enter the geofenced area. The system (e.g., predatory loan preemption system 410) may determine that the customer device (e.g., customer device 430) has entered and remained within the geofenced area for a predetermined length of time indicative of the customer receiving a predatory loan offer from the respective loan merchant. In response, the system may provide a competing loan offer alerting the customer that alternatives to the predatory loan offer exist.

In yet another example, a potential thief may have stolen the customer device (e.g., customer device 430) and has decided to use the customer device to fraudulently request a loan from a potentially predatory loan merchant. As in the other examples, the system (e.g., predatory loan preemption system 410) may determine that the customer device has entered and remained within a geofenced area associated with a potentially predatory loan merchant. The identity of the loan merchant as a predatory loan merchant may be verified based on an identified merchant category code associated with the geofenced area. An authentication may be requested from the customer device, but also secretly an authentication confirmation may be transmitted to the customer via the customer secondary contact information to further verify the identity of the customer. To further discourage theft, the system may transmit a false authentication confirmation to the customer device and alert local police authorities responsive to receiving a confirmation from the customer secondary contact information that an unauthorized transaction is pending. The system may take additional measures, such as disabling a transaction card associated with the customer and beginning a fraud monitoring routine for a predetermined number of subsequent transactions.

Examples of the present disclosure relate to systems and methods for preempting a customer's acceptance of a predatory loan offer. In one aspect, a system for preempting customer acceptance of predatory loan offers is disclosed. The system may implement a method according to the disclosed embodiments. The system may store customer account data associated with a customer and customer contact information. The customer contact information may include primary contact information corresponding to a customer device associated with the customer and secondary contact information that is different from the primary contact information. The system may determine an applicable first loan tier of a plurality of loan tiers each associated with a predetermined loan offer. The first loan tier may be indicative of a financial health of the customer. The determination of the applicable first loan tier may be based on the customer account data. The system may receive a GPS signal indicative of a first event in which the customer device enters and remains within a geofenced area for a first predetermined timeframe. The geofenced area may be associated with a first loan merchant of a plurality of loan merchants. The system may identify a merchant category code associated with the first loan merchant. The system may determine whether the first loan merchant is a predatory loan provider by comparing the identified merchant category code with one or more merchant category codes associated with predatory loan providers. In response to determining that the first loan merchant is a predatory loan provider, the system may update the customer account data based on the first event. The system may determine an applicable second loan tier of the plurality of loan tiers based on the updated customer account data. The second loan tier may be indicative of a higher risk loan than the first loan tier. The system may request an authentication from the customer device within a second predetermined timeframe. When the authentication is not received within the second predetermined timeframe, the system may transmit a fraud alert message to the customer via the secondary contact information and initiate a fraud monitoring routine for the customer. When the authentication is received within the second predetermined timeframe, the system may transmit a predetermined second loan offer associated with the applicable second loan tier to the customer device.

In some embodiments, the authentication is selected from the group consisting of logging into a financial account associated with the customer and receiving an associated device signal from a device associated with the customer device, or combinations thereof.

In some embodiments, the first predetermined time period is determined based at least in part on a trained machine learning model configured to estimate a length of time indicative of the customer applying for a loan from the first loan merchant.

In some embodiments, the second loan offer may include directions to a nearest financial service provider location associated with the second loan offer. The second loan offer may only be accepted in person.

In some embodiments, the customer account data includes prior transaction data, late payment data, and low balance data.

In some embodiments, both the first loan offer and the second loan offer are based on and have a lower interest rate than an average predatory loan offer associated with the identified merchant category code.

In some embodiments, the customer account data includes at least one source selected from customer account data from a financial service provider and customer account data from the loan merchant.

In another aspect, a system for preempting customer acceptance of first-tier loan offers is disclosed. The system may implement a method according to the disclosed embodiments. The system may store customer account data and customer contact information. The customer account data may be associated with a customer. The customer contact information may correspond to a customer device associated with the customer. The system may receive a GPS signal indicative of a first event in which the customer device enters and remains within a geofenced area for a first predetermined timeframe. The geofenced area may be associated with a first loan merchant of a plurality of loan merchants. The system may identify a merchant category code associated with the first loan merchant. The system may determine that the first loan merchant is a first-tier loan provider based at least in part on the identified merchant category code. The system may update the customer account data based on the first event responsive to determining that the first loan merchant is a first-tier loan provider. The system may request an authentication from the customer device within a second predetermined timeframe based on the first event. When the authentication is not received within the second predetermined timeframe, the system may transmit a fraud alert message to the customer via the customer contact information and initiate a fraud monitoring routine for the customer. When the authentication is received within the second predetermined timeframe, the system may generate a first loan offer based on the updated customer account data and transmit the first loan offer to the customer device.

In some embodiments, the authentication is selected from the group consisting of logging into a financial account associated with the customer and receiving an associated device signal from a device associated with the customer device, or combinations thereof.

In some embodiments, the first predetermined time period is determined based at least in part on a trained machine learning model configured to estimate a length of time indicative of the customer applying for a loan from the first loan merchant.

In some embodiments, the first loan offer includes directions to a nearest financial service provider location associated with the first loan offer. The first loan offer may only be accepted in person.

In some embodiments, the customer account data includes prior transaction data, late payment data, and low balance data.

In some embodiments, the first loan offer is based on and has a lower interest rate than an average first-tier loan offer. The first loan offer may be based in part on an average interest rate of known first-tier loan offers.

In some embodiments, the customer account data may include at least one source selected from customer account data from a financial service provider and customer account data from the loan merchant.

In yet another aspect, a device for preempting customer acceptance of predatory loan offers is disclosed. The device may implement a method according to the disclosed embodiments. The device may transmit, to one or more servers, customer account data and customer contact information. The customer account data may be associated with a customer and the customer contact information may correspond to the device associated with the customer. The device may transmit a request to the one or more servers to determine an applicable first loan tier of a plurality of loan tiers. The plurality of loan tiers may each be associated with a predetermined loan offer. The applicable first loan tier may be determined based on customer account data, and the first loan tier may be indicative of a financial health of the customer. The device may transmit, to the one or more servers, a GPS signal. The GPS signal may be indicative of a first event in which the device enters and remains within a geofenced area for a first predetermined timeframe. The geofenced area may be associated with a first loan merchant of a plurality of loan merchants. The device may receive an authentication request from the one or more servers. The device may prompt the customer to complete the authentication request within a second predetermined timeframe responsive to receiving the authentication request. The device may receive customer input associated with an authentication attempt. The device may determine whether to authenticate the customer. The device may authenticate the customer by (i) verifying the customer input associated with the authentication attempt and (ii) determining whether the customer input was received within a second predetermined timeframe. Responsive to not authenticating the customer the device may transmit an authentication failure to the one or more servers, receive and not display a fraud alert message from the one or more servers, and cause the one or more servers to initiate a fraud monitoring routine for the customer. In response to authenticating the customer, the device may transmit an authentication confirmation to the one or more servers and receive a predetermined loan offer associated with a second loan tier of the plurality of loan tiers. The predetermined loan offer associated with the second loan tier may be determined to apply to the customer based on an updated version of the customer account data that factors in the first event.

In some embodiments, the first predetermined time period may be determined based at least in part on a trained machine learning model configured to estimate a length of time indicative of the customer applying for a loan from the first loan merchant.

In some embodiments, the second loan offer may include directions to a nearest financial service provider associated with the second loan offer. The second loan offer may only be accepted in person.

In some embodiments, the authentication may be selected from the group consisting of logging into a financial account associated with the customer and receiving an associated device signal from a secondary device associated with the device, or combinations thereof.

In some embodiments, the customer account data includes prior transaction data, late payment data, and low balance data.

In some embodiments, both the first loan offer and the second loan offer are based on and have a lower interest rate than an average loan offer associated with the first loan merchant.

The specific configurations, machines, and the size and shape of various elements can be varied according to particular design specifications or constraints requiring customer devices 430, financial service provider database(s) 440, predatory loan preemption system 410, loan merchant database(s) 450, system 400, or methods 100, 200, and 300 to be constructed according to the principles of this disclosure. Such changes are intended to be embraced within the scope of this disclosure. The presently disclosed examples, therefore, are considered in all respects to be illustrative and not restrictive. The scope of the disclosure is indicated by the appended claims, rather than the foregoing description, and all changes that come within the meaning and range of equivalents thereof are intended to be embraced therein.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain examples and implementations of the disclosed technology are described above with reference to block and flow diagrams of systems and methods and/or computer program products according to example examples or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some examples or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, examples or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some examples,” “example embodiment,” “various examples,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising,” “containing,” or “including” it is meant that at least the named element, or method step is present in article or method, but does not exclude the presence of other elements or method steps, even if the other such elements or method steps have the same function as what is named.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain examples of this disclosure have been described in connection with what is presently considered to be the most practical and various examples, it is to be understood that this disclosure is not to be limited to the disclosed examples, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain examples of the technology and also to enable any person skilled in the art to practice certain examples of this technology, including making and using any apparatuses or systems and performing any incorporated methods. The patentable scope of certain examples of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for preempting customer acceptance of predatory loan offers, the system comprising:
one or more processors; and
memory, in communication with the one or more processors, and storing instructions that, when executed, are configured to cause the system to:
store customer account data associated with a customer and customer contact information comprising primary contact information corresponding to a customer device associated with the customer and secondary contact information different from the primary contact information;
determine, based on the customer account data, an applicable first loan tier of a plurality of loan tiers each associated with a predetermined loan offer, the first loan tier being indicative of a financial health of the customer;
receive a GPS signal indicative of a first event in which the customer device enters and remains within a geofenced area for a first predetermined timeframe, the geofenced area being associated with a first loan merchant of a plurality of loan merchants;
identify a merchant category code associated with the first loan merchant;
determine whether the first loan merchant is a predatory loan provider by comparing the identified merchant category code with one or more merchant category codes associated with predatory loan providers;
responsive to determining that the first loan merchant is a predatory loan provider, update the customer account data based on the first event;
determine an applicable second loan tier of the plurality of loan tiers based on the updated customer account data, the second loan tier indicative of a higher risk loan than the first loan tier;
request an authentication from the customer device within a second predetermined timeframe;
when the authentication is not received within the second predetermined timeframe:
transmit a fraud alert message to the customer via the secondary contact information; and
initiate a fraud monitoring routine for the customer; and
when the authentication is received within the second predetermined timeframe:
transmit a predetermined second loan offer associated with the applicable second loan tier to the customer device.

2. The system of claim 1, wherein the authentication is selected from the group consisting of logging into a financial account associated with the customer and receiving an associated device signal from a device associated with the customer device, or combinations thereof.

3. The system of claim 1, wherein the first predetermined timeframe is determined based at least in part on a trained machine learning model configured to estimate a length of time indicative of the customer applying for a loan from the first loan merchant.

4. The system of claim 1, wherein the predetermined second loan offer comprises directions to a nearest financial service provider location associated with the predetermined second loan offer, wherein the predetermined second loan offer can only be accepted in person.

5. The system of claim 1, wherein the customer account data comprises prior transaction data, late payment data, low balance data.

6. The system of claim 1, wherein both a predetermined first loan offer and the predetermined second loan offer are based on and have a lower interest rate than an average predatory loan offer associated with the identified merchant category code.

7. The system of claim 1, wherein customer account data comprises at least one source selected from customer account data from a financial service provider and customer account data from the first loan merchant.

8. A system for preempting customer acceptance of first-tier loan offers, the system comprising:
one or more processors; and
memory, in communication with the one or more processors, and storing instructions that, when executed, are configured to cause the system to:
store customer account data associated with a customer and customer contact information corresponding to a customer device associated with the customer;
receive a GPS signal indicative of a first event in which the customer device enters and remains within a geofenced area for a first predetermined timeframe, the geofenced area being associated with a first loan merchant of a plurality of loan merchants;
identify a merchant category code associated with the first loan merchant;
determine that the first loan merchant is a first-tier loan provider based at least in part on the identified merchant category code;
update the customer account data based on the first event responsive to determining that the first loan merchant is a first-tier loan provider;
request an authentication from the customer device within a second predetermined timeframe based on the first event;
when the authentication is not received within the second predetermined timeframe:
transmit a fraud alert message to the customer via the customer contact information; and
initiate a fraud monitoring routine for the customer; and
when the authentication is received within the second predetermined timeframe:
generate a first loan offer based on the updated customer account data; and
transmit the first loan offer to the customer device.

9. The system of claim 8, wherein the authentication is selected from the group consisting of logging into a financial account associated with the customer and receiving an associated device signal from a device associated with the customer device, or combinations thereof.

10. The system of claim 8, wherein the first predetermined timeframe is determined based at least in part on a trained machine learning model configured to estimate a length of time indicative of the customer applying for a loan from the first loan merchant.

11. The system of claim 8, wherein the first loan offer comprises directions to a nearest financial service provider location associated with the first loan offer, wherein the first loan offer can only be accepted in person.

12. The system of claim 8, wherein the customer account data comprises prior transaction data, late payment data, low balance data.

13. The system of claim 8, wherein the first loan offer is based on and has a lower interest rate than an average first-tier loan offer, the first loan offer being based in part on an average interest rate of known first-tier loan offers.

14. The system of claim 8, wherein the customer account data comprises at least one source selected from customer account data from a financial service provider and customer account data from the loan merchant.

15. A device for preempting customer acceptance of predatory loan offers, comprising:
one or more processors; and
memory, in communication with the one or more processors, and storing instructions that, when executed, are configured to cause the device to:
transmit, to one or more servers, customer account data associated with a customer and customer contact information corresponding to the device associated with the customer;
transmit a request to the one or more servers to determine, based on the customer account data, an applicable first loan tier of a plurality of loan tiers each associated with a predetermined loan offer, the first loan tier being indicative of a financial health of the customer;
transmit, to the one or more servers, a GPS signal indicative of a first event in which the device enters and remains within a geofenced area for a first predetermined timeframe, the geofenced area being associated with a first loan merchant of a plurality of loan merchants;
receive an authentication request from the one or more servers;
prompt the customer to complete the authentication request within a second predetermined timeframe responsive to receiving the authentication request;
receive customer input associated with an authentication attempt;
determine whether to authenticate the customer by (i) verifying the customer input associated with the authentication attempt and (ii) determining whether the customer input was received within the second predetermined timeframe;
responsive to not authenticating the customer:
transmit an authentication failure to the one or more servers;
receive and not display a fraud alert message from the one or more servers; and
cause the one or more servers to initiate a fraud monitoring routine for the customer;
responsive to authenticating the customer:
transmit an authentication confirmation to the one or more servers; and
receive a predetermined second loan offer associated with a second loan tier of the plurality of loan tiers determined to apply to the customer based on an updated version of the customer account data that factors in the first event.

16. The device of claim 15, wherein the first predetermined timeframe is determined based at least in part on a trained machine learning model configured to estimate a length of time indicative of the customer applying for a loan from the first loan merchant.

17. The device of claim 15, wherein the predetermined second loan offer comprises directions to a nearest financial service provider location associated with the predetermined second loan offer, wherein the predetermined second loan offer can only be accepted in person.

18. The device of claim 15, wherein the authentication is selected from the group consisting of logging into a financial account associated with the customer and receiving an associated device signal from a secondary device associated with the device, or combinations thereof.

19. The device of claim 15, wherein the customer account data comprises prior transaction data, late payment data, low balance data.

20. The device of claim 15, wherein both a predetermined first loan offer and the predetermined second loan offer are based on and have a lower interest rate than an average loan offer associated with the first loan merchant.
